(19) United States
(12) Patent Application Publication
(10) Pub. No.: US 2024/0247690 A1
(43) Pub. Date: Jul. 25, 2024

(54) CONCENTRIC CLUTCH SLAVE CYLINDER ASSEMBLY AND CLUTCH COMPRISING SAID ASSEMBLY

(71) Applicant: Schaeffler Technologies AG & Co. KG, Herzogenaurach (DE)

(72) Inventors: Felipe Gimenes Camargo, Sorocaba (BR); Bruno Corsi Alabarse, Sorocaba (BR)

(73) Assignee: Schaeffler Technologies AG & Co. KG, Herzogenaurach (DE)

(21) Appl. No.: 18/422,401

(22) Filed: Jan. 25, 2024

(30) Foreign Application Priority Data
Jan. 25, 2023 (BR) 10 2023 001376 7

(51) Int. Cl. F16D 25/08

(52) U.S. Cl. CPC F16D 25/08

(57) ABSTRACT

Concentric clutch slave cylinder assembly having a housing and a connector, the housing having a main axis, a main cylinder, an outer concentric cylinder such that an annular chamber is defined. A tubular piston may be slidably mounted on the main cylinder such that it closes the annular chamber. The housing includes a fluid channel connected to the annular chamber and having an axis perpendicular to the main axis. The connector may be joined to the fluid channel such that the connector and the fluid channel have a common axis, the connector having a connection interface to an external tube, wherein the connector and the housing form a single part.

### CROSS-REFERENCE TO RELATED APPLICATIONS

This application claims the benefit of Brazilian Patent Application No. BR 1020230013767, filed Jan. 25, 2023, the disclosure of which is incorporated in its entirety by reference herein.

### TECHNICAL FIELD

The present disclosure belongs to the specific sector of concentric clutch slave cylinders that constitute an essential part of the clutch.

### BACKGROUND

Known are in the art concentric clutch slave cylinder assemblies. These assemblies are aimed at pressing the discs of a clutch. For this purpose, they are connected to a pedal or an equivalent component by means of a hydraulic connection.

The assemblies comprise a housing and a connector. The housing comprises a main cylinder having a main axis, and an outer concentric cylinder. Therefore, a passage in the interior of the main cylinder is defined and an annular chamber is defined between the inner cylinder and the outer cylinder. This geometry allows to mount a tubular piston between the main cylinder and the outer cylinder such that the tubular cylinder closes the annular chamber.

For moving the tubular piston, a fluid channel is connected to the annular chamber. The fluid channel is arranged with their axis arranged perpendicular to the main axis.

The fluid channel is continued by the connector, and in known solutions the fluid channel and the connector have a common axis. The connector is provided with a connection interface such that it can be connected to a standard external tube.

The disadvantage is that the housing and the connector, usually manufactured in different places have to mutually fit so that both manufacturers have to manufacture with strict tolerances, and also an O-ring is needed to guarantee tightness. As shown in FIG. 1, the assembly is done with a metallic elastic pin to lock the connector C to the housing H, and with an O-ring, which must endure the working pressure of the fluid and ensure the leak proofness. The metallic elastic pin is usually crimped to avoid disassembly during the work life by vibrations.

Finally, these connectors are made of aluminum and must be completely machined to cover all necessary profiles and roughness specifications. The profile must ensure that the assembly is possible without any harm for any component, considering the process dimensional variations. The surface roughness is another essential characteristic, specially on the O-ring seat, to ensure the leak proofness in different pressure and temperature conditions of its application. The aluminum is a cost-effective cost option due its robustness, thermal stability and corrosion resistance without any additional process. Polymers can also be applied when the volume demand justify an investment in a high cost tooling.

### SUMMARY

For overcoming the state of the art limitations, the present disclosure proposes a concentric clutch slave cylinder assembly comprising a housing and a connector, the housing comprising a main axis, a main cylinder, an outer concentric cylinder such that an annular chamber is defined, a tubular piston slidably mounted on the main cylinder such that it closes annular the chamber, the housing comprising a fluid channel connected to the annular chamber and having an axis perpendicular to the main axis, the connector being joined to the fluid channel such that the connector and the fluid channel have a common axis, the connector comprising a connection interface to an external tube, characterised in that the connector and the housing form a single part.

Therefore, the inventive solution includes a connector that can be injected with the housing, while the connection interface respects the shape of the counterpart, i.e. the flexible duct, thus allowing the fluid flow through the system. Another benefit of the disclosure is that the roughness of the interface can also be controlled. Therefore, the solution allows: to avoid a connection, and then an O-ring; not depending on a supplier for the connector; controlling the finishing and quality of the O-ring.

In some embodiments, the connection interface comprises a retaining ring. In some embodiments, the assembly comprises a helicoidal spring mounted concentrically with the main cylinder between the housing and the tubular piston. In some embodiments, the housing and the connector that form a single part are made of plastic. In some embodiments, the fluid channel has a constant diameter. In some embodiments, the assembly comprises a filling and purging port. In some embodiments, the axis of the filling and purging port is perpendicular to the main axis. In some embodiments, the outer diameter of the assembly around the fluid channel has three portions with growing diameters from the connection to the annular chamber to the interface.

The disclosure also relates to a clutch comprising an assembly according to any of the embodiments listed above.

### BRIEF DESCRIPTION OF THE DRAWINGS

To complete the description and in order to provide for a better understanding of the disclosure, a set of drawings is provided. Said drawings form an integral part of the description and illustrate an embodiment of the disclosure, which should not be interpreted as restricting the scope of the disclosure, but just as an example of how the disclosure can be carried out. The drawings comprise the following figures:

FIG. 1 shows a housing and a connector assembly according to a known embodiment, in which both parts are different parts and there is a union between them by means of an O-ring.

FIGS. 2 and 3 show perspectives of the assembly shown in FIG. 1, assembled and disassembled respectively.

FIG. 4 shows a section of the assembly according to the present disclosure, where the material continuity between the housing and the connector can be seen.

FIG. 5 shows the detail of the connector, identical to prior art on the tube interface side, but different on the housing connection side.

FIGS. 6 and 7 show perspectives of the assembly, with the difference that in FIG. 7 the piece for retaining the flexible tube is shown disassembled.

### DETAILED DESCRIPTION

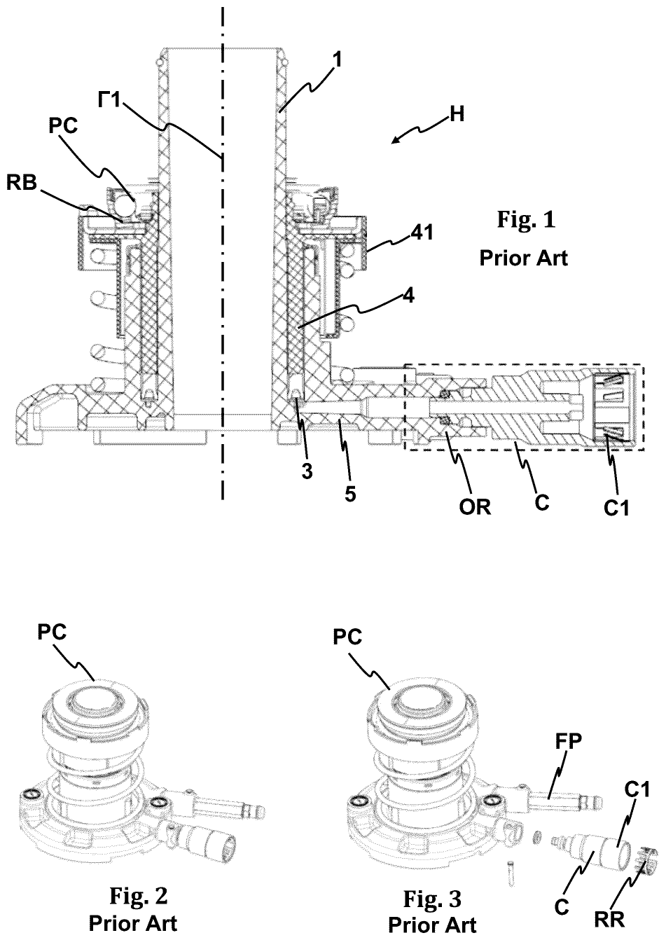

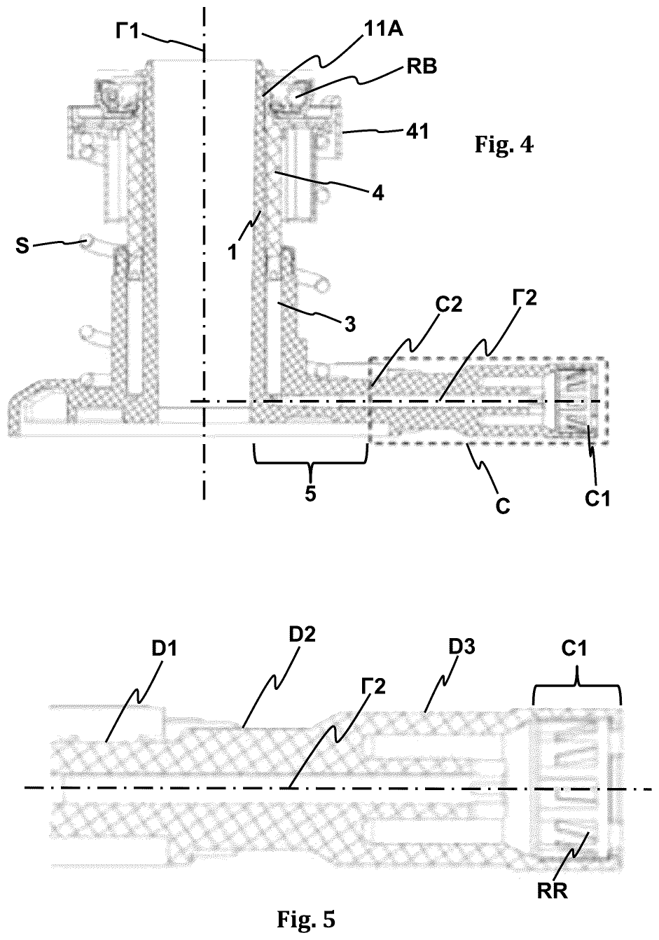

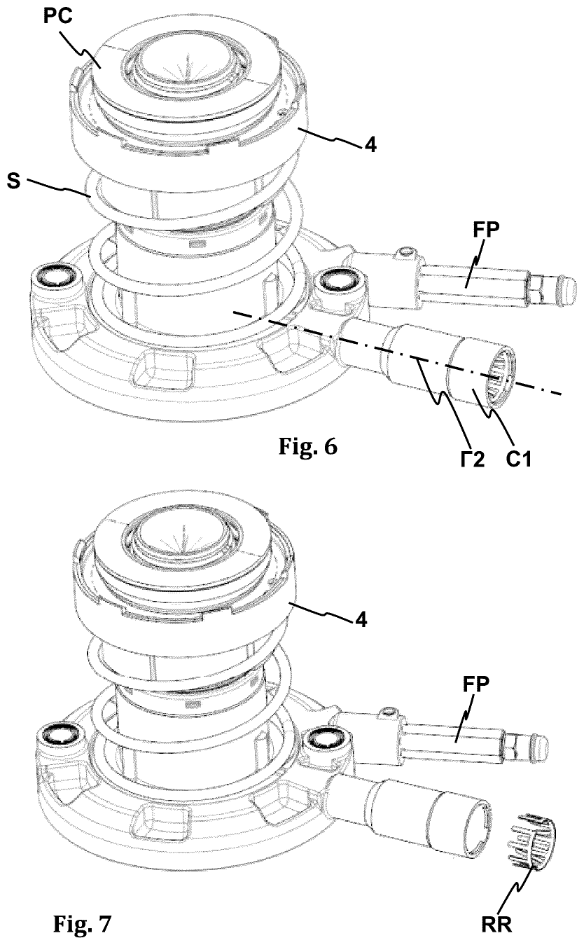

As shown in FIG. 1, according to an embodiment, the disclosure relates to a concentric clutch slave cylinder CCSC assembly A comprising a housing H and a connector C.

The housing H comprises a main axis Γ1, a main cylinder 1, an outer concentric cylinder 2 such that an annular chamber 3 is defined. A tubular piston 4 is slidably mounted on the main cylinder 1 such that it closes the annular the chamber 3.

The housing H comprises a fluid channel 5 connected to the annular chamber 3 and has an axis Γ2 perpendicular to the main axis Γ1.

According to the disclosure, the connector C is joined to the fluid channel 5 such that the connector C and the fluid channel 5 have a common axis Γ2, the connector C comprising a connection interface C1 to an external tube T, the connector C and the housing H forming a single part.

As shown in FIG. 7, the connection interface comprises a retaining ring RR.

The assembly A also comprises, in a known manner, a helicoidal spring S mounted concentrically with the main cylinder 1 between the housing H and the tubular piston 4.

According to an advantageous aspect, the housing H and the connector C form a single part are made of plastic.

As shown in FIG. 5. the fluid channel 5 has a constant diameter, such that there are no changes of pressure along the duct. That can be helpful also for the manufacturing process, with tooling with less complex geometries. The constant diameter my vary according to the application, usually from 3 to 6 mm.

As shown in the figures, the assembly A also comprises a filling and purging port FP. This port FP is distinct from the main connector, aimed at controlling the clutch.

In all the embodiments, and in a known manner, the axis of the filling and purging port FP is perpendicular to the main axis Γ1.

In the embodiments shown, and as depicted in FIG. 5, the outer diameter D1, D2, D3 of the assembly A around the fluid channel 5 has three portions with growing diameters D1, D2, D3 from the connection to the annular chamber 5 to the interface C1.

In this text, the term “comprises” and its derivations (such as “comprising”, etc.) should not be understood in an excluding sense, that is, these terms should not be interpreted as excluding the possibility that what is described and defined may include further elements, steps, etc.

The disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

What is claimed is:

1. A concentric clutch slave cylinder assembly, comprising:
a connector; and
a housing comprising:
a main axis;
a main cylinder;
an outer concentric cylinder wherein an annular chamber is defined;
a tubular piston slidably mounted on the main cylinder such that the tubular piston closes the annular chamber; and
a fluid channel connected to the annular chamber and having an axis perpendicular to the main axis, the connector being joined to the fluid channel such that the connector and the fluid channel have a common axis, the connector comprising a connection interface to an external tube, wherein the connector and the housing form a single part.

2. The assembly according to claim 1, wherein the connection interface comprises a retaining ring.

3. The assembly according to claim 1, further comprising a helicoidal spring mounted concentrically with the main cylinder between the housing and the tubular piston.

4. The assembly according to claim 1, wherein the housing and the connector that form the single part are made of plastic.

5. The assembly according to claim 1, wherein the fluid channel has a constant diameter.

6. The assembly according to claim 5, wherein the constant diameter is in the range 3 to 6 mm.

7. The assembly according to claim 1, further comprising a filling and purging port.

8. The assembly according to claim 7, wherein an axis of the filling and purging port is perpendicular to the main axis.

9. The assembly according to claim 1, wherein the outer diameter of the assembly around the fluid channel has three portions with growing diameters from the connection to the annular chamber to the interface.

10. A clutch comprising:
a concentric clutch slave cylinder assembly including a housing and a connector, the housing comprising:
a main axis;
a main cylinder;
an outer concentric cylinder wherein an annular chamber is defined;
a tubular piston slidably mounted on the main cylinder such that the tubular piston closes the annular chamber; and
a fluid channel connected to the annular chamber, the connector being joined to the fluid channel such that the connector and the fluid channel have a common axis, wherein the connector and the housing form a single part.

11. A method for manufacturing a concentric clutch slave cylinder assembly comprising:
providing a housing and a connector, wherein the housing includes a main axis, a main cylinder, and an outer concentric cylinder such that an annular chamber is defined;
mounting, slidably, a tubular piston on the main cylinder such that it closes the annular chamber;
connecting a fluid channel of the housing to the annular chamber;
joining the connector to the fluid channel such that the connector and the fluid channel have a common axis; and
molding altogether the connector and the housing such that they form a single part.
